(19) United States
(12) Patent Application Publication
(10) Pub. No.: US 2019/0079602 A1
(43) Pub. Date: Mar. 14, 2019

(54) INPUT DEVICE

(71) Applicant: Primax Electronics Ltd., Taipei (TW)

(72) Inventors: Tung-Heng WU, Taipei (TW); Ying-Che TSENG, Taipei (TW)

(21) Appl. No.: 15/833,759

(22) Filed: Dec. 6, 2017

(30) Foreign Application Priority Data
Sep. 8, 2017 (TW) 106130840

(51) Int. Cl. G06F 3/038; G06F 3/0354; G06F 3/0346

(52) U.S. Cl. CPC G06F 3/0383; G06F 3/0346; G06F 3/03544

(57) ABSTRACT

An input device includes a proximity sensor, a displacement sensor and a microprocessor. The proximity sensor detects whether an object is close to or in contact with the input device. The displacement sensor detects a moving status of the input device and outputs a corresponding trajectory signal. The microprocessor is electrically connected with the proximity sensor and the displacement sensor. An operation mode of the input device is switched according to detected values of the proximity sensor and the displacement sensor.

### FIELD OF THE INVENTION

The present invention relates to an input device, and more particularly to a cursor indicating device, in which the operation mode of the cursor indicating device is switchable according to the operation state.

### BACKGROUND OF THE INVENTION

A mouse is used to control a cursor on a computer screen in order to operate the computer. Since 1968, the United States has produced the world's first mouse. After then, the mouse is applied to paper processing operations, video games, industrial drawings, drawing design or media production. Consequently, the mouse has become an indispensable part of the computer system. In the early stage, the mouse uses a trackball to detect the displacement of the mouse. With increasing development of science and technology, an optical module or a laser module is used to detect the displacement of the mouse in order to enhance the working efficiency. Moreover, for increasing the functionality and convenience of the mouse, the earliest wired single-button mouse is gradually evolved into the modern wireless multi-button roller mouse. For complying with different industrial needs or personal preferences, various electronic manufacturers have begun to create a variety of mouse devices with different shapes or with composite functions in order to meet the operation requirements of different users.

In accordance with the existing technology, the mouse device is classified into an ordinary mouse and an air mouse. A composite mouse with both functions of the ordinary mouse and the air mouse has been introduced into the market. However, the composite mouse is usually equipped with plural keys for switching and operating the functions of the mouse. As known, the complicated design of the keys is not user-friendly. Moreover, when the composite mouse is used as the ordinary mouse, an optical sensing module or a laser sensing module is widely used to detect the moving trajectory of the composite mouse on a working surface. However, the material, the flatness level or the angle of the working surface may influence the performance of the optical sensing module or the laser sensing module on detecting the moving trajectory. Consequently, the composite mouse cannot output the cursor trajectory signal stably.

For solving the drawbacks of the conventional technologies, there is a need of providing a multi-function composite input device that has a simple design and is operated on various working surfaces with different materials, flatness levels or angles.

### SUMMARY OF THE INVENTION

The present invention provides a multi-function composite input device that has a simple design. The multi-function composite input device can be operated on various working surfaces with different materials, flatness levels or angles in order to output the stable cursor trajectory signal.

In accordance with an aspect of the present invention, there is provided an input device. The input device includes a proximity sensor, a displacement sensor and a microprocessor. The proximity sensor detects whether an object is close to or in contact with the input device. The displacement sensor detects a moving status of the input device and outputs a corresponding trajectory signal. The microprocessor is electrically connected with the proximity sensor and the displacement sensor. An operation mode of the input device is switched according to detected values of the proximity sensor and the displacement sensor.

In an embodiment, the proximity sensor is a capacitive proximity sensor, an inductive proximity sensor, an electromagnetic proximity sensor, an optical proximity sensor, a microwave proximity sensor or an ultrasonic proximity sensor.

In an embodiment, the displacement sensor is a piezoelectric acceleration sensor, a piezoresistive acceleration sensor, a capacitive acceleration sensor or a G-sensor.

In an embodiment, if the detected value of the proximity sensor in a hexadecimal format is in a range between 70 and 80 and changes of the detected values of an X momentum, a Y momentum and a Z momentum of the displacement sensor in the hexadecimal format are lower than 0 F, the input device pairs with at least one electronic computing device through wireless communication.

In an embodiment, the operation mode includes a first working mode, a second working mode and a hibernation mode.

In an embodiment, if the detected value of the proximity sensor in a hexadecimal format is higher than 80 and a change of the detected value of an X momentum, a Y momentum or a Z momentum of the displacement sensor in the hexadecimal format is higher than 10, the input device is in the first working mode.

In an embodiment, if the detected value of the proximity sensor in a hexadecimal format is lower than 70 and a change of the detected value of an X momentum, a Y momentum or a Z momentum of the displacement sensor in the hexadecimal format is higher than 20, the input device is in the second working mode.

In an embodiment, if the detected value of the proximity sensor in a hexadecimal format is lower than 70 and changes of the detected values of an X momentum, a Y momentum and a Z momentum of the displacement sensor in the hexadecimal format are lower than 0 F, the input device is in the hibernation mode.

In an embodiment, when the input device is moved on a working surface, the microprocessor calculates an angle between the working surface and a horizontal plane through the displacement sensor and performs a two-dimensional plane correction according to the angle.

In an embodiment, when the displacement sensor detects a moving trajectory of the input device on the working surface, the displacement sensor generates a two-dimensional trajectory signal and a cursor movement is controlled according to the two-dimensional trajectory signal.

In an embodiment, when the displacement sensor detects a moving trajectory of the input device in a three-dimensional space, the displacement sensor generates a three-dimensional trajectory signal. Moreover, a cursor movement, a display interface zoom in/out action or a display interface switching action is controlled according to the three-dimensional trajectory signal.

In an embodiment, the input device includes an upper cover and a lower cover.

In an embodiment, the upper cover includes a scroll wheel, at least one button part and a transparent window.

In an embodiment, the lower cover has a bottom surface, and the input device is moved on a working surface through the bottom surface.

In an embodiment, the proximity sensor emits a detecting signal toward the transparent window to detect whether the object is close to or in contact with the input device.

In an embodiment, the input device further includes a laser diode module, and the laser diode module emits a laser beam with a pointing function in a direction toward the transparent window.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating an input device according to an embodiment of the present invention;

FIG. 2 is a schematic cross-sectional view illustrating the input device according to an embodiment of the present invention;

FIGS. 3A and 3B schematically illustrate the operations of the input device of the present invention in the first working mode;

FIGS. 4A to 4D schematically illustrate the operations of the input device of the present invention in the second working mode; and

FIG. 5 schematically illustrates the use of the input device of the present invention as a laser pointer.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

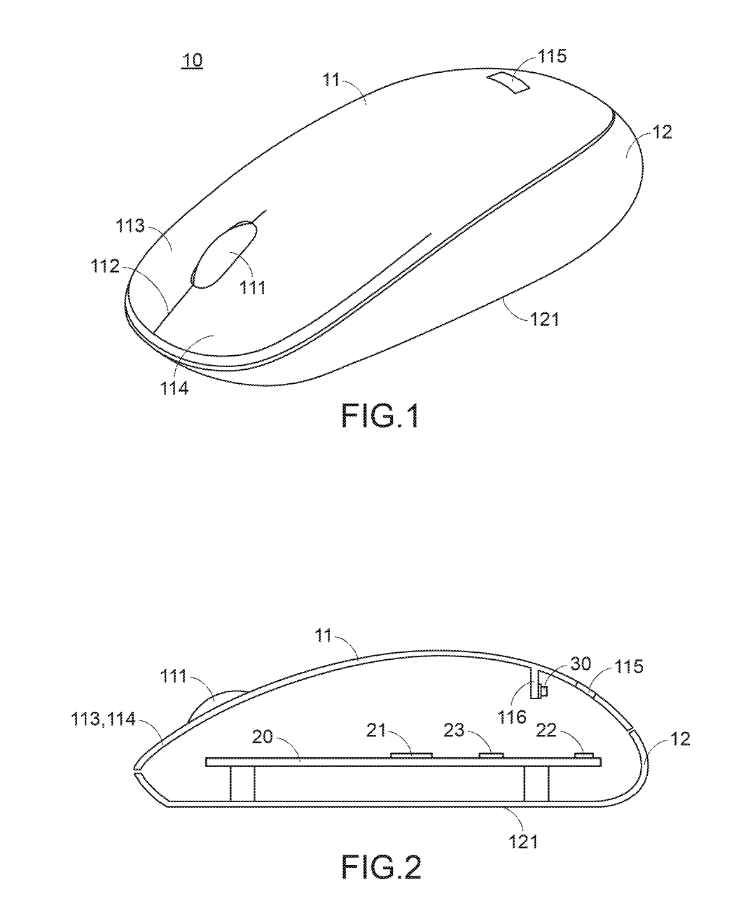

Please refer to FIGS. 1 and 2. FIG. 1 is a schematic perspective view illustrating an input device according to an embodiment of the present invention. FIG. 2 is a schematic cross-sectional view illustrating the input device according to an embodiment of the present invention. As shown in FIG. 1, the input device 10 is a cursor indicating device. The input device 10 is in communication with an electronic computing device such as a computer (not shown) according to a wireless communication protocol (e.g., Bluetooth or Wi-Fi). Consequently, the motion of a cursor on a display device (not shown) of the electronic computing device is correspondingly controlled. The input device 10 comprises a top cover 11 and a bottom cover 12. A front side of the upper cover 11 is a control terminal. The control terminal comprises a scroll wheel 111, a gap 112 and two button parts 113, 114. The button parts 113 and 114 are separated by the gap 112. A rear side of the upper cover 11 is a holding terminal. A surface of the holding terminal comprises a transparent window 115. The lower cover 12 has a bottom surface 121. The input device 10 can be operated and moved on a working surface through the bottom surface 121.

Please refer to FIG. 2. As shown in FIG. 2, an accommodation space is formed between the upper cover 11 and the lower cover 12 of the input device 10. A circuit board 20 is disposed within the accommodation space. The circuit board 20 comprises a microprocessor 21, a proximity sensor 22 and a displacement sensor 23. The circuit board 20 is fixed on an inner surface of the lower cover 12. A supporting structure 116 is protruded downwardly from an inner surface of the top cover 11. A laser diode module 30 is installed on the supporting structure 116. The microprocessor 21 is electrically connected with the proximity sensor 22, the displacement sensor 23 and the laser diode module 30. Under control of the microprocessor 21, the proximity sensor 22 emits a detecting signal toward the transparent window 115 in order to detect whether an object is close to or in contact with the surface of the rear holding terminal of the upper cover 11 of the input device 10. As the detected object is closer to the input device 10, the detected value of the proximity sensor 22 increases. Under control of the microprocessor 21, the laser diode module 30 emits a laser beam with a pointing function in the direction toward the transparent window 115. Moreover, while the input device 10 is moved, the microprocessor 21 acquires the change of the detected value of an X momentum, a Y momentum or a Z momentum through the displacement sensor 23. Moreover, according to the moving status of the input device 10, the microprocessor 21 issues a corresponding trajectory signal to the electronic computing device. According to the trajectory signal, the motion of the cursor on the display device of the electronic computing device is correspondingly controlled.

The proximity sensor 22 is a capacitive proximity sensor, an inductive proximity sensor, an electromagnetic proximity sensor, an optical proximity sensor, a microwave proximity sensor, an ultrasonic proximity sensor, or a combination of these proximity sensors. The displacement sensor 23 is a piezoelectric acceleration sensor, a piezoresistive acceleration sensor, a capacitive acceleration sensor, a G-sensor, or a combination of these acceleration sensors. Moreover, a wireless communication module (not shown) and a storage unit (not shown) are installed on the circuit board 20. The wireless communication module is used for performing Bluetooth or Wi-Fi connection. The storage unit is used for storing an operation mode software and one or plural link keys. When the operation mode software is executed by the microprocessor 21, the operation mode of the input device 10 is switchable.

Please refer to FIG. 2 again. In accordance with the present invention, the microprocessor 21 switches the operation mode of the input device 10 according to the detected value of the proximity sensor 22 and the change of the detected value of the displacement sensor 23. In an embodiment, the detected values are expressed in a hexadecimal format.

In an embodiment, the input device 10 is in wireless communication with the electronic computing device according to the Bluetooth communication protocol. According to the detected values of the proximity sensor 22 and the displacement sensor 23, the microprocessor 21 establishes the Bluetooth connection between the input device 10 and the electronic computing device. A process of establishing the wireless communication will be described as follows. When the input device 10 is used at a first time, an object (e.g., the user' palm) is close to the transparent window 115 at the rear holding terminal of the upper cover 11. Since the proximity sensor 22 detects that the user's palm is close to the input device 10, a detected value is generated. In an embodiment, the detected value of the proximity sensor 22 in the hexadecimal format is in the range between 70 and 80. Since the input device 10 is not moved, the changes of the detected values of the X momentum, the Y momentum and the Z momentum of the displacement sensor 23 in the hexadecimal format are lower than 0 F. Meanwhile, the microprocessor 21 detects the electronic computing device in the surroundings through the wireless communication module. According to a received signal strength indication (RSSI) value of the wireless communication, the input device 10 pairs with one or plural nearby electronic computing devices. At the same time, one or plural link keys for establishing the wireless communications are generated. Then, the generated link keys are stored in the storage unit by the microprocessor 21.

The operation mode built in the input device 10 includes a first working mode, a second working mode and a hibernation mode. During the operation of the input device 10, the input device 10 is selectively switched between the first working mode, the second working mode and the hibernation mode according to the detected value of the proximity sensor 22 and the change of the detected value of the displacement sensor 23 in real time. In case that the input device 10 is in the first working mode, the input device 10 is used as an ordinary mouse. In case that the input device 10 is in the second working mode, the input device 10 is used as an air mouse. The hibernation mode is a power-saving mode.

The rule of determining the operation mode of the input device 10 will be listed in Table 1. Table 1 is a look-up table illustrating the operation mode corresponding to the proximity sensor 22 and the displacement sensor 23.

TABLE 1

| Operation mode | proximity sensor | displacement sensor |
|---|---|---|
| First working mode | O | O |
| Second working mode | X | O |
| Hibernation mode | X | X |

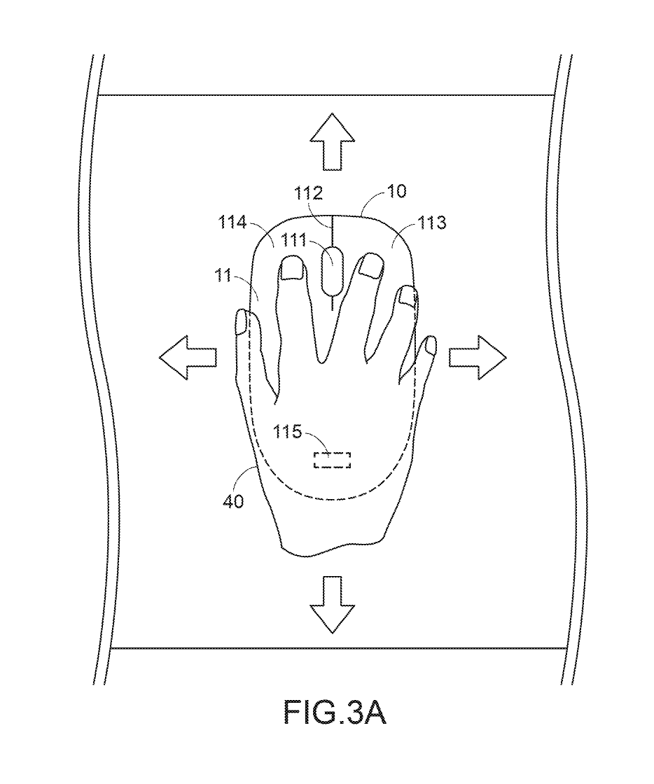

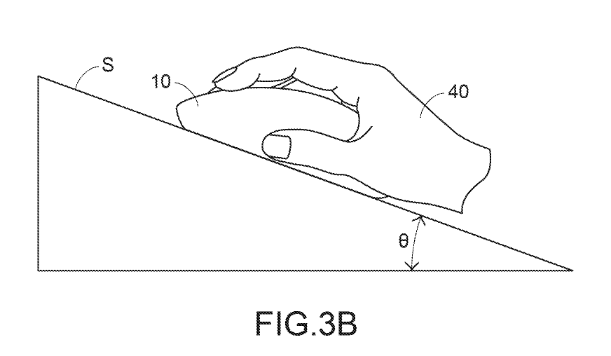

Please refer to Table 1 and FIGS. 3A and 3B. FIGS. 3A and 3B schematically illustrate the operations of the input device of the present invention in the first working mode.

Please refer to FIG. 3A. The palm of the user 40 is contacted with the transparent window 115 at the rear holding terminal of the upper cover 11, and the input device 10 is moved by the user 40. Under this circumstance, the proximity sensor 22 detects the contact of the user's palm, and the displacement sensor 23 detects the movement of the input device 10 on the working surface. Consequently, the proximity sensor 22 and the displacement sensor 23 generate the detected values.

In case that the detected value of the proximity sensor 22 in the hexadecimal format is higher than 80, the detection status of the proximity sensor 22 is indicated as “O” in Table 1. In case that the change of the detected value of the X momentum, the Y momentum or the Z momentum of the displacement sensor 23 in the hexadecimal format is higher than 10, the detection status of the displacement sensor 23 is indicated as “O” in Table 1. If the detection status of the proximity sensor 22 and the detection status of the displacement sensor 23 are both indicated as “O”, the microprocessor 21 detects the electronic computing device in the surroundings through the wireless communication module. In addition, the microprocessor 21 compares the link keys in the storage unit. If the link key complies with a specified electronic computing device, the wireless communication between the input device 10 and the specified electronic computing device is established. Meanwhile, the input device 10 enters the first working mode.

Please refer to FIG. 3B. In the first working mode, the input device 10 is moved on the working surface S through the bottom surface 121 (see FIG. 1 or FIG. 2). Moreover, the microprocessor 21 calculates the angle θ between the working surface S and a horizontal plane according to the detected value of the X momentum, the Y momentum or the Z momentum of the displacement sensor 23. Moreover, the microprocessor 21 performs a two-dimensional plane correction according to the angle θ. For example, in case that the working surface S is a horizontal working surface and the input device 10 is moved on the working surface S, the microprocessor 21 judges that the working surface S is the horizontal working surface because the angle θ is 0 degree. Consequently, the input device 10 generates a two-dimensional trajectory signal according to the change of the detected value of the X momentum or the Y momentum of the displacement sensor 23. In case that the working surface S is a vertical working surface and the input device 10 is moved on the working surface S, the microprocessor 21 judges that the working surface S is the vertical working surface because the angle θ is 90 degree. Consequently, the input device 10 generates a two-dimensional trajectory signal according to the changes of the detected values of the Z momentum and the Y momentum of the displacement sensor 23. In accordance with the present invention, the angle θ between the working surface S and a horizontal plane is previously obtained through the displacement sensor 23. When the input device 10 is operated and moved on the working surface S with a different angle, the two-dimensional plane correction is performed according to the angle θ. Consequently, the input device 10 generates and outputs a two-dimensional trajectory signal corresponding to the cursor movement according to the two-dimensional plane correction and the moving trajectory of the input device. The operations and signal outputting principles of the scroll wheel 111 and the button parts 113, 114 in the first working mode are similar to those of the existing cursor indicating device (i.e., the ordinary mouse), and are not redundantly described herein.

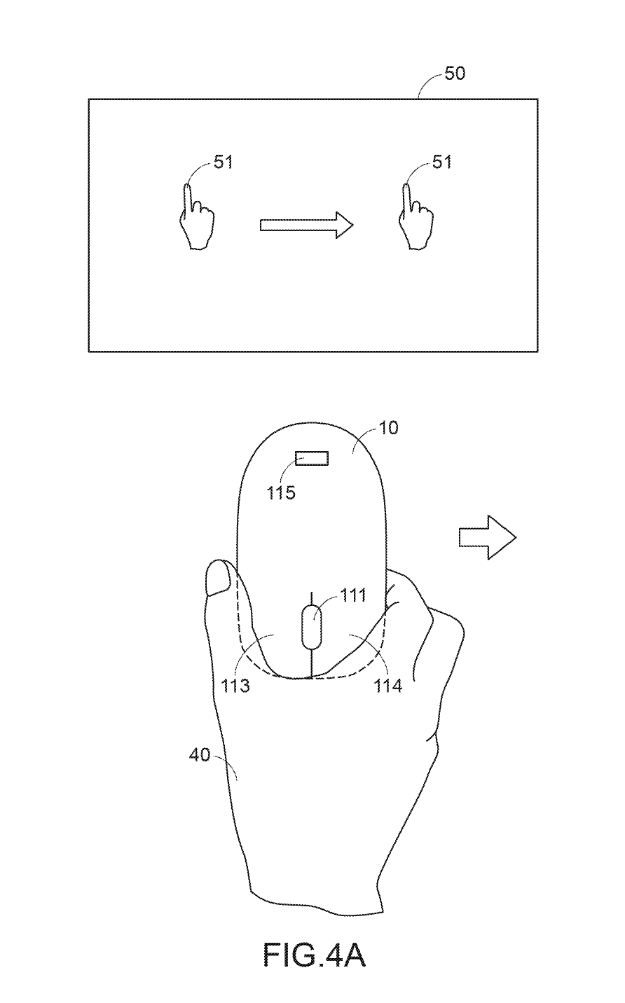

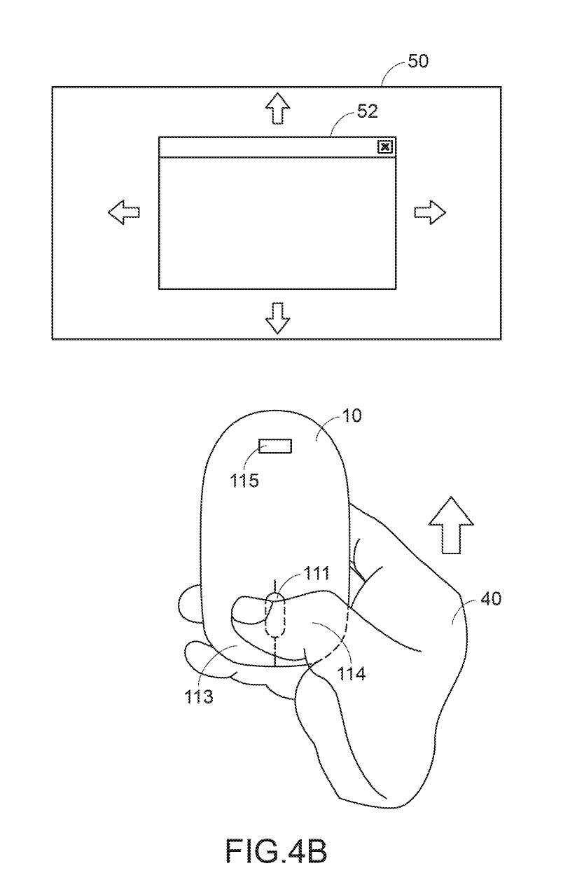

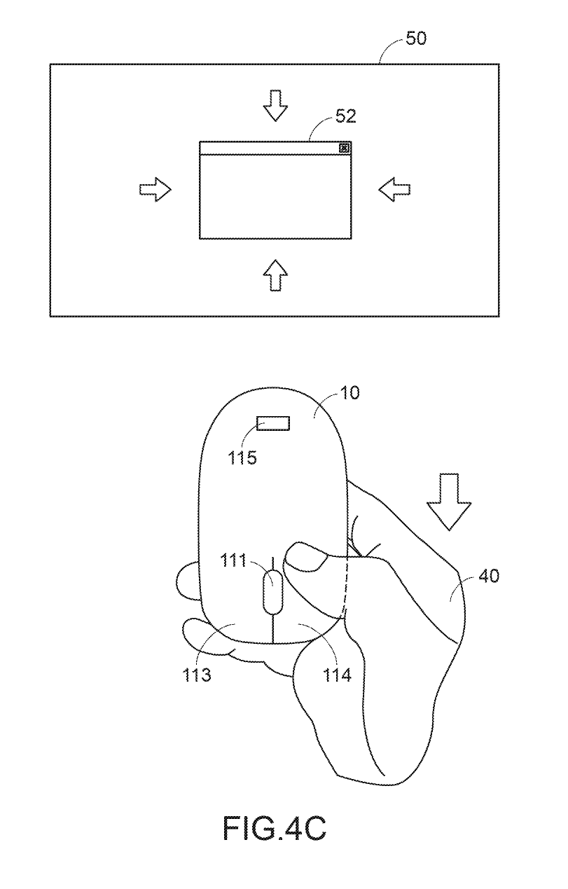

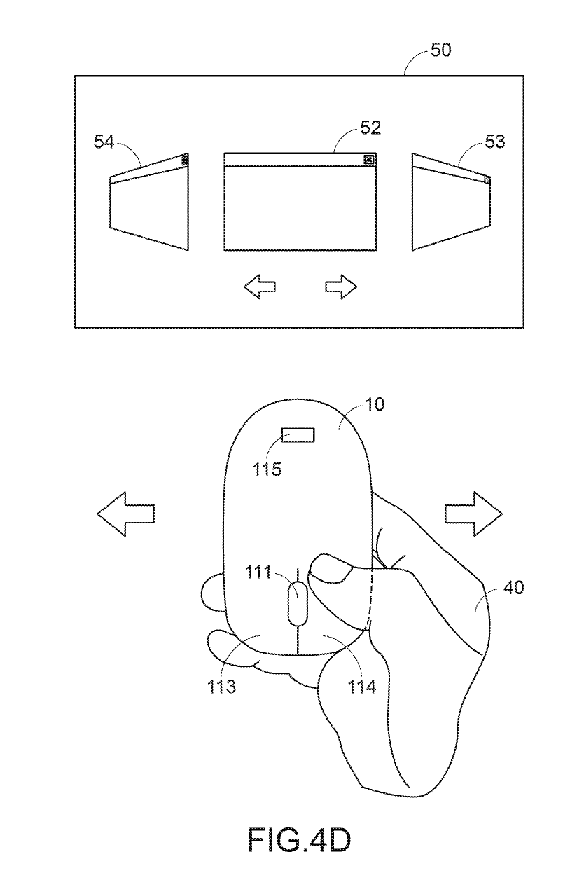

Please refer to Table 1 and FIGS. 1, 4A to 4D. FIGS. 4A to 4D schematically illustrate the operations of the input device of the present invention in the second working mode.

Please refer to FIG. 4A. The palm of the user 40 holds the front control terminal of the input device 10, and the input device 10 is moved by the user 40. Since the transparent window 115 is not sheltered by the palm of the user 40, the proximity sensor 22 does not detect the palm of the user 40. Since the displacement sensor 23 detects the movement of the input device 10, the displacement sensor 23 generates the detected values. In case that the detected value of the proximity sensor 22 in the hexadecimal format is lower than 70, the detection status of the proximity sensor 22 is indicated as “X” in Table 1. In case that the change of the detected value of the X momentum, the Y momentum or the Z momentum of the displacement sensor 23 in the hexadecimal format are higher than 20, the detection status of the displacement sensor 23 is indicated as “O” in Table 1. If the detection status of the proximity sensor 22 is indicated as “X” and the detection status of the displacement sensor 23 is indicated as “O”, the microprocessor 21 switches the operation mode of the input device 10. Meanwhile, the input device 10 enters the second working mode. In the second working mode, the input device 10 may be moved in a three-dimensional space along three dimensional directions. The input device 10 generates a three-dimensional trajectory signal according to the change of the detected value of the X momentum, the Y momentum and the Z momentum of the displacement sensor 23. According to the three-dimensional trajectory signal and the operation of the scroll wheel 111, the button part 113 or the button part 114, the cursor movement, the display interface zoom in/out action or a display interface switching action on the display device 50 of the electronic computing device is correspondingly controlled.

In the second working mode, the input device 10 as shown in FIG. 4A is used as an air mouse. Moreover, the movement of a cursor 51 on the display device 50 is controlled according to the change of the detected value of the X momentum or the Y momentum of the displacement sensor 23.

Please refer to FIGS. 4B and 4C. During the operation of the input device 10, the user 40 presses one of the button parts 113 and 114 of the input device 10 (e.g. the button part 113) and the input device 10 is moved upwardly. Meanwhile, the displacement sensor 23 detects the change of the detected value of the Z momentum. According to the change of the detected value of the Z momentum, the input device 10 zooms in a display interface 52 on the display device 50. During the operation of the input device 10, the user 40 presses another of the button parts 113 and 114 of the input device 10 (e.g. the button part 114) and the input device 10 is moved downwardly. Meanwhile, the displacement sensor 23 detects the change of the detected value of the Z momentum. According to the change of the detected value of the Z momentum, the input device 10 zooms out the display interface 52 on the display device 50.

Please refer to FIG. 4D. During the operation of the input device 10, the user 40 presses one of the button parts 113 and 114 of the input device 10 (e.g. the button part 113) and the input device 10 is moved leftwards or rightwards. Meanwhile, the displacement sensor 23 detects the change of the detected value of the X momentum or the Y momentum. According to the change of the detected value of the X momentum or the Y momentum, the input device 10 switches the display interface 52, 53 or 54 on the display device 50.

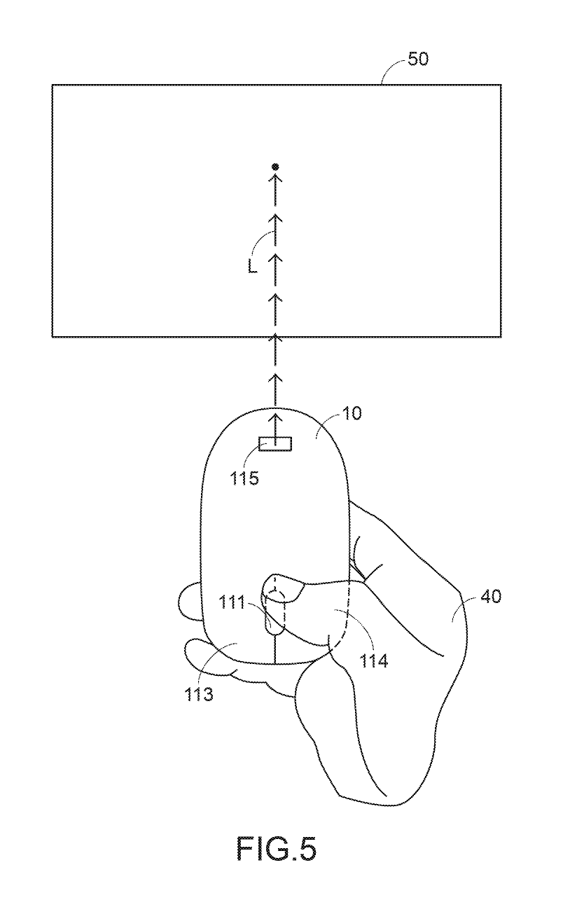

FIG. 5 schematically illustrates the use of the input device of the present invention as a laser pointer. In the second working mode, the input device 10 is also used as a laser pointer (see FIG. 5). During the operation of the input device 10, the user 40 presses the scroll wheel 111 of the input device 10. Meanwhile, the microprocessor 21 enables the laser diode module 30 (see FIG. 2). Under control of the microprocessor 21, the laser diode module 30 emits a laser beam L with a pointing function in the direction toward the transparent window 115.

Please refer to Table 1 again. In a situation, the proximity sensor 22 does not detect that any object is close to or in contact with the transparent window 115 at the rear holding terminal of the upper cover 11, and the displacement sensor 23 does not detect the movement of the input device 10. Meanwhile, since the detected value of the proximity sensor 22 in the hexadecimal format is lower than 70, the detection status of the proximity sensor 22 is indicated as “X” in Table 1. Moreover, since the change of the detected value of the X momentum, the Y momentum or the Z momentum of the displacement sensor 23 in the hexadecimal format is lower than 0 F, the detection status of the displacement sensor 23 is indicated as “X” in Table 1. If the detection status of the proximity sensor 22 and the detection status of the displacement sensor 23 are both indicated as “X”, the microprocessor 21 disables the wireless communication module and the laser diode module 30. Under this circumstance, the input device 10 is in the hibernation mode. In the hibernation mode, the input device 10 only provides a small amount of electricity to the proximity sensor 22 and the displacement sensor 23. Since the power consumption of the input device 10 is effectively reduced, the power-saving purpose is achieved or the use time of the battery (not shown) of the input device 10 is extended. It is noted that the detected values of the proximity sensor 22 and the displacement sensor 23 may be adjusted according to the types of the proximity sensor 22 and the displacement sensor 23.

From the above descriptions, the present invention provides a multi-function composite input device. According to the way of holding the input device, the operation mode of the input device is switched in real time. Consequently, the input device can be selectively used as the ordinary mouse or the air mouse. In case that the input device is used as the ordinary mouse and the input device is operated and moved on a working surface with a different angle, the two-dimensional plane correction can be previously performed. Consequently, the input device generates and outputs a two-dimensional trajectory signal corresponding to the cursor movement. In comparison with the existing mouse using the optical or laser sensing module, the multi-function composite input device of the present invention is beneficial. The multi-function composite input device of the present invention can be operated on various working surfaces with different materials, flatness levels or angles in order to output the stable cursor trajectory signal. In other words, the technology of the present invention is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An input device, comprising:
a proximity sensor detecting whether an object is close to or in contact with the input device;
a displacement sensor detecting a moving status of the input device and outputting a corresponding trajectory signal; and
a microprocessor electrically connected with the proximity sensor and the displacement sensor,
wherein an operation mode of the input device is switched according to detected values of the proximity sensor and the displacement sensor.

2. The input device according to claim 1, wherein the proximity sensor is a capacitive proximity sensor, an inductive proximity sensor, an electromagnetic proximity sensor, an optical proximity sensor, a microwave proximity sensor or an ultrasonic proximity sensor.

3. The input device according to claim 1, wherein the displacement sensor is a piezoelectric acceleration sensor, a piezoresistive acceleration sensor, a capacitive acceleration sensor or a G-sensor.

4. The input device according to claim 1, wherein if the detected value of the proximity sensor in a hexadecimal format is in a range between 70 and 80 and changes of the detected values of an X momentum, a Y momentum and a Z momentum of the displacement sensor in the hexadecimal format are lower than 0 F, the input device pairs with at least one electronic computing device through wireless communication.

5. The input device according to claim 1, wherein the operation mode includes a first working mode, a second working mode and a hibernation mode.

6. The input device according to claim 5, wherein if the detected value of the proximity sensor in a hexadecimal format is higher than 80 and a change of the detected value of an X momentum, a Y momentum or a Z momentum of the displacement sensor in the hexadecimal format is higher than 10, the input device is in the first working mode.

7. The input device according to claim 5, wherein if the detected value of the proximity sensor in a hexadecimal format is lower than 70 and a change of the detected value of an X momentum, a Y momentum or a Z momentum of the displacement sensor in the hexadecimal format is higher than 20, the input device is in the second working mode.

8. The input device according to claim 5, wherein if the detected value of the proximity sensor in a hexadecimal format is lower than 70 and changes of the detected values of an X momentum, a Y momentum and a Z momentum of the displacement sensor in the hexadecimal format are lower than 0 F, the input device is in the hibernation mode.

9. The input device according to claim 6, wherein when the input device is moved on a working surface, the microprocessor calculates an angle between the working surface and a horizontal plane through the displacement sensor and performs a two-dimensional plane correction according to the angle.

10. The input device according to claim 9, wherein when the displacement sensor detects a moving trajectory of the input device on the working surface, the displacement sensor generates a two-dimensional trajectory signal and a cursor movement is controlled according to the two-dimensional trajectory signal.

11. The input device according to claim 7, wherein when the displacement sensor detects a moving trajectory of the input device in a three-dimensional space, the displacement sensor generates a three-dimensional trajectory signal, wherein a cursor movement, a display interface zoom in/out action or a display interface switching action is controlled according to the three-dimensional trajectory signal.

12. The input device according to claim 1, wherein the input device comprises an upper cover and a lower cover.

13. The input device according to claim 12, wherein the upper cover comprises a scroll wheel, at least one button part and a transparent window.

14. The input device according to claim 12, wherein the lower cover has a bottom surface, and the input device is moved on a working surface through the bottom surface.

15. The input device according to claim 13, wherein the proximity sensor emits a detecting signal toward the transparent window to detect whether the object is close to or in contact with the input device.

16. The input device according to claim 13, wherein the input device further comprises a laser diode module, and the laser diode module emits a laser beam with a pointing function in a direction toward the transparent window.
